(19) United States
(12) Patent Application Publication
(10) Pub. No.: US 2012/0293743 A1
(43) Pub. Date: Nov. 22, 2012

(54) LIGHT EMITTING DEVICE AND LIQUID CRYSTAL DISPLAY APPARATUS

(75) Inventor: Tsuyoshi Hasegawa, Moriguchi City (JP)

(73) Assignee: SANYO ELECTRIC CO., LTD., Osaka (JP)

(21) Appl. No.: 13/472,641

(22) Filed: May 16, 2012

(30) Foreign Application Priority Data
May 19, 2011 (JP) 2011-111965

(51) Int. Cl. G02F 1/1335; F21V 17/04; F21V 8/00

(52) U.S. Cl. 349/62; 362/611; 362/612

(57) ABSTRACT

Provided is a light emitting device including: a light source; and a light guide plate that receives light emitted by the light source and emits it from a light emitting surface thereof. The light emitting device is provided with a fixing mechanism for fixing the light guide plate to a main body side of the light emitting device by using a structure that does not inhibit thermal expansion of the light guide plate.

### CROSS-REFERENCE TO RELATED APPLICATIONS

The present application is based on Japanese Patent Application No. 2011-111965 filed in Japan on May 19, 2011, all the contents of which are hereby incorporated by reference.

### BACKGROUND OF THE INVENTION

1. Field of the Invention

The present invention relates to a light emitting device having a light guide plate and a liquid crystal display apparatus including the same.

2. Description of Related Art

Conventionally, a light emitting device having a light guide plate is used as, for example, a backlight device provided in a liquid crystal display apparatus. The following briefly describes one example (conventional example) of such a light emitting device with reference to FIGS. 12 and 13.

FIG. 12 shows a schematic sectional view (a view taken along a plane as a cross section, which is perpendicular to a light emitting surface of a light guide plate) of a light emitting device according to the conventional example. As shown in FIG. 12, a light emitting device 101 as the light emitting device according to the conventional example has a substantially plate-shaped metal frame 111, and a heat sink plate 112 is fixed to one edge on the metal frame 111.

Furthermore, in the light emitting device 101, in order from the side closer to the metal frame 111, a reflective plate 114, a light guide plate 115 (whose surface on the upper side in FIG. 12 is a light emitting surface), a diffusion sheet 116, a prism sheet 117, and a diffusion sheet 118 are provided parallel to one another. The reflective plate 114 and the light guide plate 115 are provided so as to be partly placed on the heat sink plate 112.

In the light emitting device 101, a plurality of LEDs 113a that serve as light sources are also provided so as to be aligned in a row. The LEDs 113a are provided at a prescribed LED light bar, and the LED light bar is mounted to the heat sink plate 112, so that the LEDs 113a in the row lie along one side surface of the light guide plate 115.

Furthermore, the metal frame 111 is provided with a columnar protrusion 111a for performing both positioning and fixing of the reflective plate 114 and the light guide plate 115, and the reflective plate 114 and the light guide plate 115 are each provided with a cutout portion corresponding in shape to the columnar protrusion 111a.

As shown in FIG. 13 (the reflective plate 114 is not shown in this figure), the reflective plate 114 and the light guide plate 115 are fixed to the metal frame 111 (i.e. to a main body side of the light emitting device 101) by fitting the columnar protrusion 111a into the cutout portion. There is provided no flexibility (freeplay) area between the cutout portion and the columnar protrusion 111a, and the light guide plate 115, therefore, is fixed so as to be immovable in a direction parallel to the light emitting surface.

The light emitting device 101 is configured as above and thus realizes a side-edge type backlight device. When the LEDs 113a emit light, as shown by arrows in FIG. 12, the light enters the light guide plate 115 from the side surface thereof. The light that has thus entered impinges on, for example, a dot pattern at a lower portion of the light guide plate 115 or the reflective plate 114 and then emerges from the light emitting surface of the light guide plate 115.

The light that has emerged from the light emitting surface of the light guide plate 115 passes through the diffusion sheet 116, the prism sheet 117, and the diffusion sheet 118 and then is radiated as backlight to the outside. The backlight is inputted to a liquid crystal panel, which is provided on a front surface side of the light emitting device 101 (the upper side in FIG. 12), and used for image display.

In a light emitting device using a light guide plate, the light guide plate may undergo thermal expansion. This thermal expansion is attributable mainly to heat accompanying light emission by light sources (in the above-described conventional example, the LEDs), and such heat is conducted to the light guide plate to cause the thermal expansion. Particularly in a case of a side-edge type backlight device, a reduced number of light sources are used, and in compensation therefor, an increased amount of an electric current is fed therethrough, so that heat tends to be concentrated at part of a light guide plate.

In a configuration in which, as in the above-described conventional example, a light guide plate and a columnar protrusion are in substantially intimate contact with each other (there is provided no flexibility area between them), thermal expansion of the light guide plate is inhibited by the columnar protusion, so that thermal stress is generated in the light guide plate. This might result in the occurrence of bending of the light guide plate as shown in FIGS. 14A and 14B.

In FIG. 14A, part of light that is supposed to enter the light guide plate 115 is impinging on the reflective plate 114. In FIG. 14B, part of light that is supposed to enter the light guide plate 115 is impinging on the diffusion sheet 116. Light that has failed to properly enter the light guide plate 115 is different in luminance, color temperature, and so on from light that has properly entered the light guide plate 115, thus causing display unevenness on a liquid crystal screen.

### SUMMARY OF THE INVENTION

A light emitting device according to the present invention includes: a light source; and a light guide plate that receives light emitted by the light source and emits it from a light emitting surface thereof. The light emitting device is provided with a fixing mechanism for fixing the light guide plate to a main body side of the light emitting device by using a structure that does not inhibit thermal expansion of the light guide plate. Herein, the “main body of the light emitting device” refers to part or entirety of a portion of the light emitting device exclusive of the light guide plate, and a specific configuration thereof is not particularly limited.

Furthermore, a liquid crystal display apparatus according to the present invention includes: the light emitting device according to the above-described configuration that emits, from the light emitting surface, light to used as backlight; and a liquid crystal panel that has a plurality of pixels and in which the degree of transmission of the backlight is adjusted for each of the plurality of pixels so that an image is displayed.

### DESCRIPTION OF DRAWINGS

The object and features of the present invention can be further clarified by referring to the following description of preferred working examples and the appended drawings showing the following.

FIG. 1 is a configuration view of a backlight device according to an embodiment of the present invention.

FIG. 2 is a sectional view of the backlight device according to the embodiment of the present invention.

FIG. 3 is an external view of a light guide plate according to the embodiment of the present invention.

FIG. 4 is an external view of a metal frame according to the embodiment of the present invention.

FIG. 5 is another external view of the metal frame according to the embodiment of the present invention.

FIG. 6 is an external view of a columnar component according to the embodiment of the present invention.

FIG. 7 is an explanatory view showing a state where a heat sink plate and the columnar component are mounted.

FIG. 8 is an explanatory view showing a state where the light guide plate and so on are mounted.

FIG. 9 is an explanatory view showing a state where the light guide plate is thermally expanded.

FIG. 10 is an explanatory view showing, as another example, the state where the light guide plate and so on are mounted.

FIG. 11 is an explanatory view showing, as another example, the state where the light guide plate is thermally expanded.

FIG. 12 is a sectional view of a light emitting device according to a related art.

FIG. 13 is an explanatory view showing a state where a light guide plate and so on according to the related art are mounted.

FIG. 14A and FIG. 14B show explanatory views related to bending of the light guide plate.

### DESCRIPTION OF PREFERRED EMBODIMENTS

By exemplarily using a backlight device (one form of the light emitting device) for a liquid crystal display apparatus, the following describes an embodiment of the present invention.

[Overall Configuration, etc. of Backlight Device]

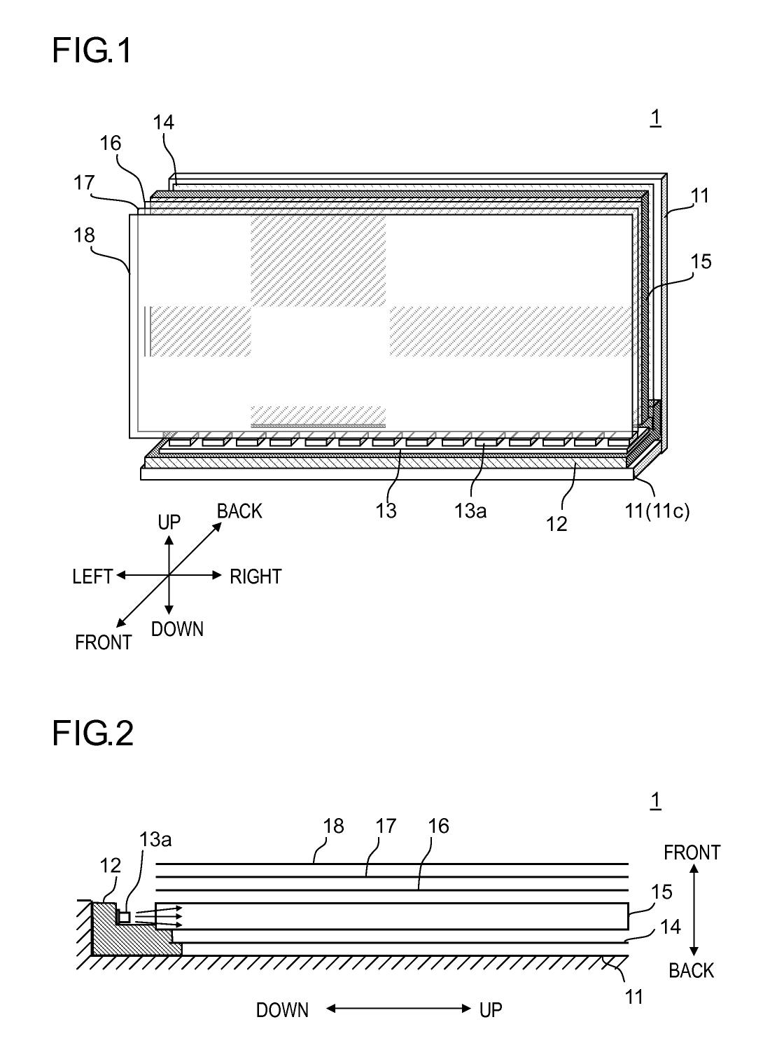

FIG. 1 is a schematic configuration view of a backlight device as seen from an obliquely upper front side. Furthermore, FIG. 2 is a schematic sectional view (a view taken along a plane as a cross section, which is perpendicular to a light emitting surface of a light guide plate) of the backlight device as seen from a lateral side. In the following description, unless otherwise specified, upper and lower directions (vertical direction), right and left directions (lateral direction), and front and back directions (front-back direction) are defined as shown by arrows in FIG. 1. Furthermore, in FIG. 2, the upper side corresponds to the front side, and the lower side corresponds to the back side.

As shown in these figures, a backlight device 1 has a metal frame 11, a heat sink plate 12, an LED light bar 13, a reflective plate 14, a light guide plate 15, a diffusion sheet 16, a prism sheet 17, a diffusion sheet 18, and so on.

The metal frame 11 is a substantially plate-shaped member made of metal and performs functions such as fixing various components of the backlight device 1 and protecting them from an external impact. The configuration of the metal frame 11 will be described again later in more detail.

The heat sink plate 12 is fixed to one edge on the metal frame 11 and performs a function of dissipating heat generated by the LED light bar 13 and so on.

Furthermore, in the backlight device 1, in order from the side closer to the metal frame 11, the reflective plate 14, the light guide plate 15 (whose surface on the front side is a light emitting surface), the diffusion sheet 16, the prism sheet 17, and the diffusion sheet 18 are provided parallel to one another. The reflective plate 14 and the light guide plate 15 are provided so as to be partly placed on the heat sink plate 12.

The reflective plate 14 is a plate-shaped component that is formed to reflect light from the front side back to the front side, and the light guide plate 15 is a plate-shaped component that is formed to emit, from the light emitting surface, light that has entered from a side surface thereof. Furthermore, the diffusion sheets (16, 18) are sheets that diffuse light, and the prism sheet 17 is a sheet that has an effect of focusing light onto the front side.

On the LED light bar 13, a plurality of LEDs 13a that serve as light sources are provided so as to be aligned in a row. The LED light bar 13 is mounted to the heat sink plate 12 so that the LEDs 13a in the row lie along a lower side surface of the light guide plate 15. The LEDs 13a are therefore arranged so as to be opposed to the lower side surface of the light guide plate 15.

The backlight device 1 is configured as above and thus realizes a side-edge type backlight device. When the LEDs 13a emit light, as shown by arrows in FIG. 2, the light enters the light guide plate 15 from the side surface thereof. The light that has thus entered impinges on, for example, a dot pattern at a lower portion of the light guide plate 15 or the reflective plate 14 and then emerges from the light emitting surface of the light guide plate 15.

Light that emerges from the light emitting surface of the light guide plate 15 passes through the diffusion sheet 16, the prism sheet 17, and the diffusion sheet 18 and is used as backlight for image display. That is, in a liquid crystal display apparatus having the backlight device 1, a liquid crystal panel is provided on the front side of the backlight device 1, and backlight is radiated toward the liquid crystal panel. The liquid crystal panel has a plurality of pixels, and the degree of transmission of backlight is adjusted for each of the plurality of pixels so that an image is displayed.

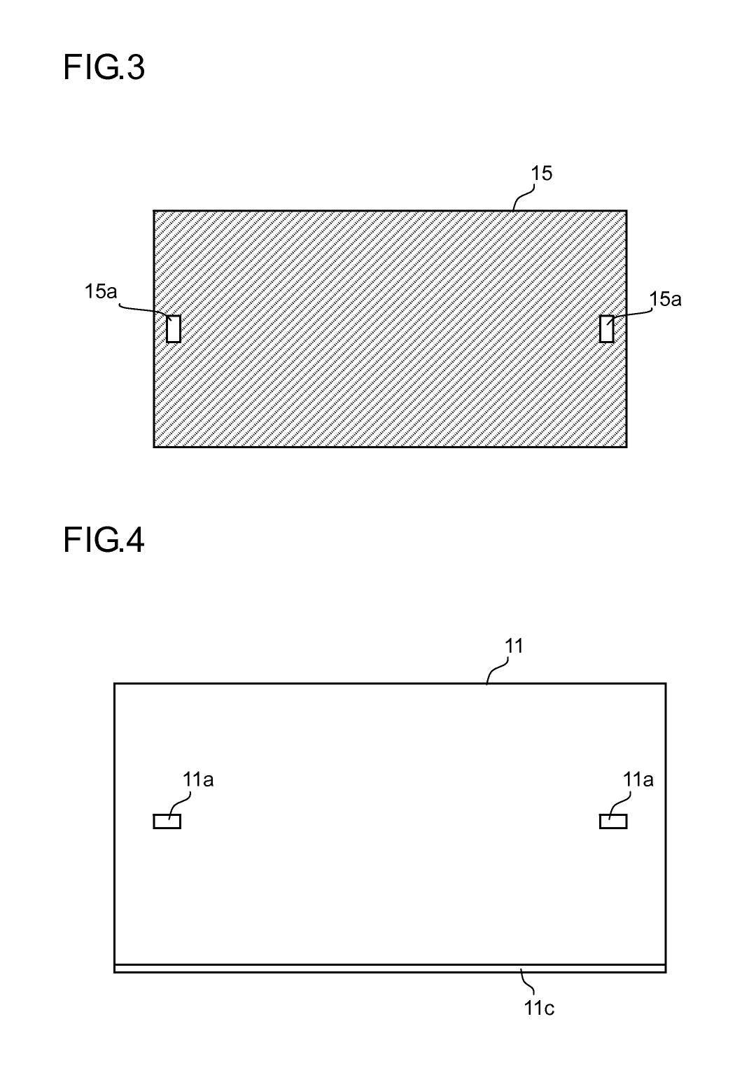

FIG. 3 is an external view of the light guide plate 15 as seen from the front side. As shown in this figure, the light guide plate 15 is in the shape of a plate having a rectangular outer rim and has a hole 15a on each of the right and left sides thereof, which penetrates therethrough in the front-back direction. When seen from the front side, the hole 15a has a rim in the shape of a rectangle that is longer in the vertical direction than in the lateral direction. As will be described later, the hole 15a functions as part of a fixing mechanism for fixing the light guide plate 15 to the metal frame 11.

FIG. 4 is an external view of the metal frame 11 as seen from the front side. As shown in this figure, the metal frame 11 is in the shape of a plate having a rectangular outer rim and has a hole 11a on each of the right and left sides thereof, which penetrates therethrough in the front-back direction. When seen from the front side, the hole 11a has a rim in the shape of a rectangle that is longer in the lateral direction than in the vertical direction. As will be described later, the hole 11a functions as part of the fixing mechanism for fixing the light guide plate 15 to the metal frame 11.

Furthermore, at a front surface of the metal frame 11, a support portion 11c is provided so as to protrude to the front side along a lower edge thereof. FIG. 5 is an external view of the metal frame 11 as seen from the back side. As shown in this figure, a groove 11b is formed on each of the upper and lower sides with respect to each of the holes 11a so as to extend in the lateral direction.

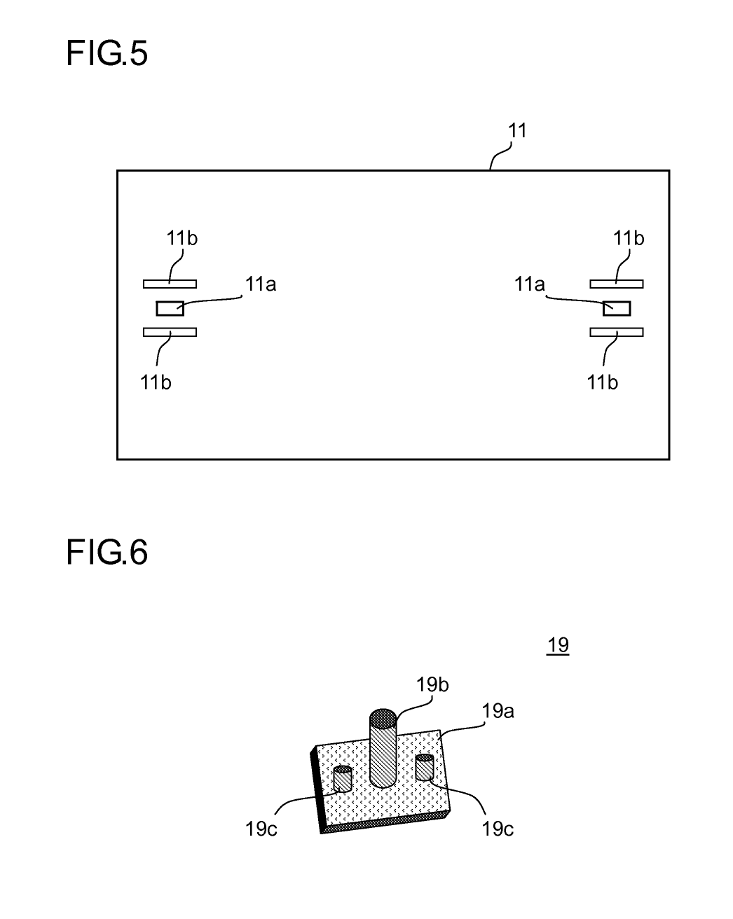

Furthermore, in the backlight device 1, a columnar component 19 is provided that is a component used for performing both positioning and fixing of the light guide plate 15. FIG. 6 is an external view of the columnar component 19. As shown in this figure, the columnar component 19 has a configuration in which a columnar portion 19b and guide portions 19c protrude in the same direction from a surface of a plate-shaped base portion 19a. The columnar portion 19b has a length in its protruding direction sufficiently longer than the thickness of the metal frame 11.

The columnar portion 19b and the guide portions 19c are each in the shape of a cylinder having an axis coinciding with their protruding direction. The diameter of the columnar portion 19b is set to conform to the width of the hole 15a and to the width of the hole 11a, and the diameter of the guide portions 19c is set to conform to the width of the groove 11b. Furthermore, the distance between the columnar portion 19b and each of the guide portions 19c is set to be equal to the distance between the hole 11a and the groove 11b. As will be described later, the columnar component 19 also functions as part of the fixing mechanism for fixing the light guide plate 15 to the metal frame 11.

[Regarding Fixing of Light Guide Plate to Metal Frame]

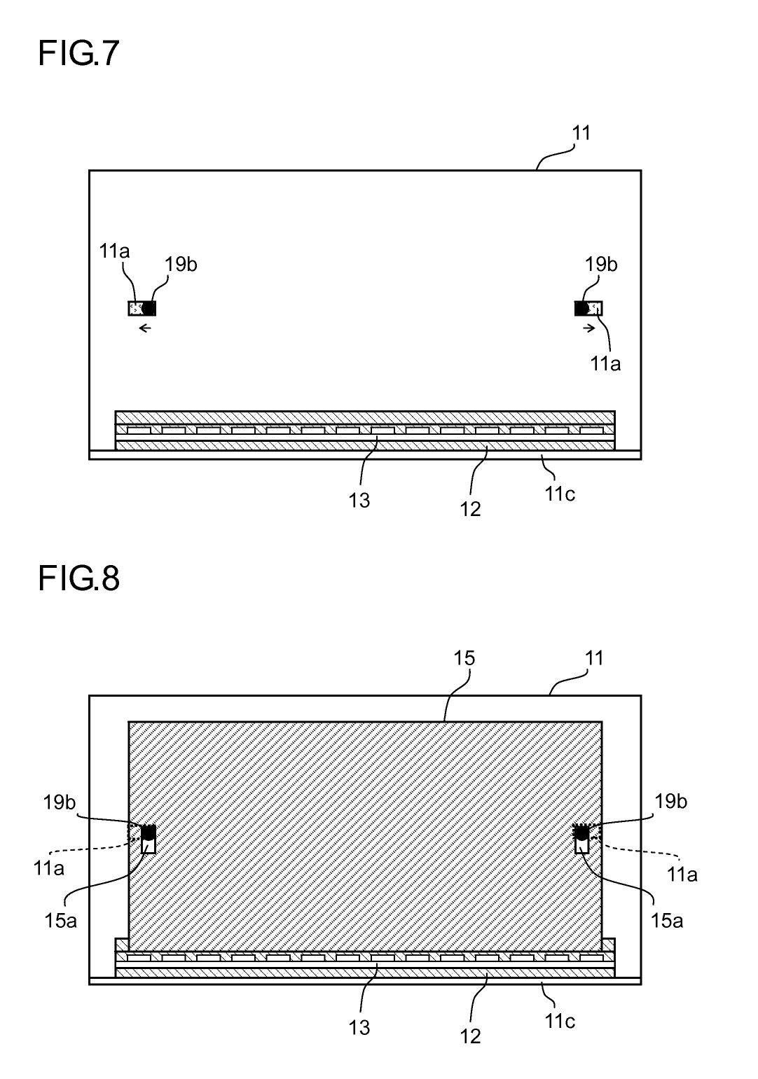

Fixing of the light guide plate 15 to the metal frame 11 (this can be regarded also as positioning thereof mainly in a direction parallel to the light emitting surface) is achieved by use of the columnar component 19 and so on. Next, the following describes step by step how the light guide plate 15 is fixed to the metal frame 11. FIG. 7 shows a state where the heat sink plate 12 (to which the LED light bar 13 has already been mounted) and the columnar component 19 are mounted to the metal frame 11.

The heat sink plate 12 is mounted by being supported by the front surface of the metal frame 11 and the support portion 11c. On the rear side of the metal frame 11, the columnar component 19 is mounted by fitting the guide portions 19c into the grooves 11b, respectively, and by fitting the columnar portion 19b into the hole 11a (at an inward position within the hole 11a). The columnar portion 19b protrudes to the front side from the front surface of the metal frame 11.

Since the hole 11a and the groove 11b each extend in the lateral direction, the columnar component 19 is movable in the lateral direction along the hole 11a and the groove 11b. In a state shown in FIG. 7, each of the columnar components 19 is movable outward in the lateral direction as indicated by an arrow.

FIG. 8 shows a state where, in addition to the heat sink plate 12 and the columnar component 19, the light guide plate 15 is mounted to the metal frame 11. The light guide plate 15 is mounted by being supported at a lower edge thereof by the heat sink plate 12 and by fitting the columnar portion 19b into the hole 15a (at an upward position within the hole 15a). In a state shown in FIG. 8, the light guide plate 15 is movable upward by an amount corresponding to a difference in size between the hole 15a and the columnar portion 19b.

As described above, fixing (positioning) of the light guide plate 15 with respect to the metal frame 11 (a main body side of the backlight device 1) is performed by using a structure having a flexibility area (a flexibility area for preventing thermal expansion of the light guide plate 15 from being inhibited) in the direction parallel to the light emitting surface. In other words, the light guide plate 15 is fixed to the metal frame 11 such that freeplay is provided in the direction parallel to the light emitting surface. Thus, even when the light guide plate 15 undergoes thermal expansion due to heat accompanying light emission by the LEDs 13a being conducted thereto, there hardly occurs bending or the like of the light guide plate 15.

More specifically, when the LEDs 13a are in a non-light emitting state, the light guide plate 15 is in the state shown in FIG. 8. When, for example, the power of the backlight device 1 is turned on to cause the LEDs 13a to start light emission, heat accompanying the light emission is conducted to the light guide plate 15 to cause it to be thermally expanded in a gradual manner.

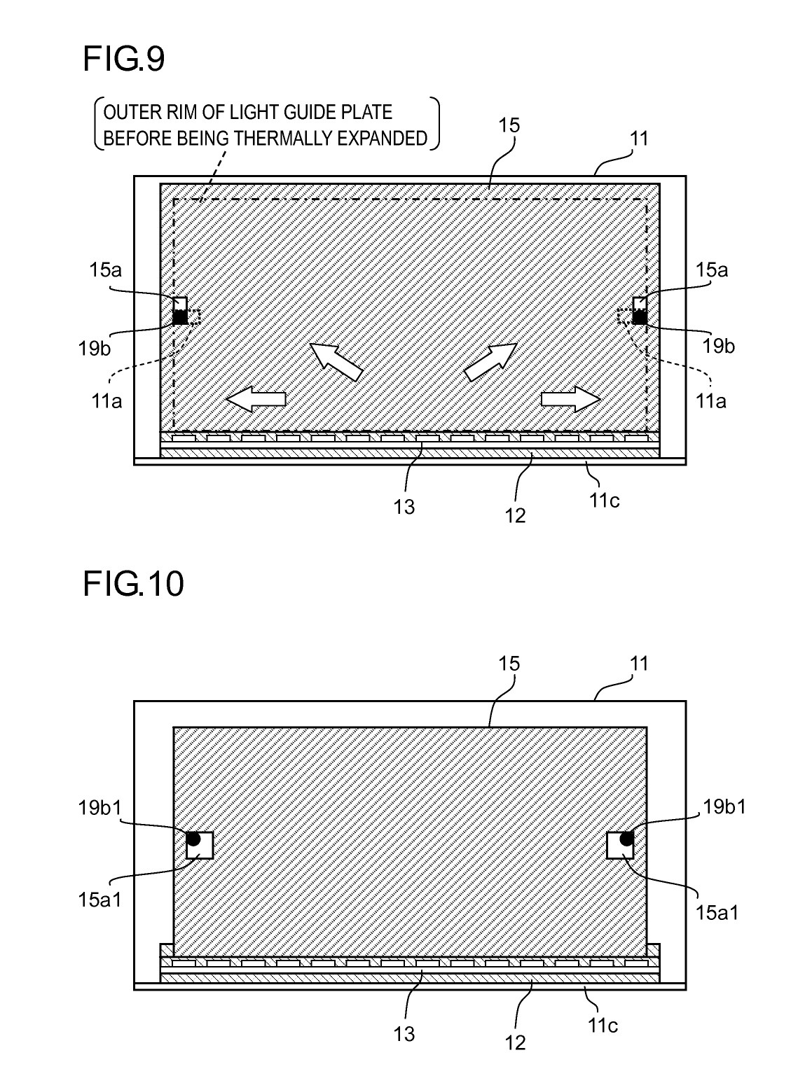

At this time, since the lower edge of the light guide plate 15 is supported by the heat sink plate 12, with respect to the direction parallel to the light emitting surface, the light guide plate 15 is thermally expanded substantially in directions indicated by arrows in FIG. 9 and is eventually brought to a state shown in FIG. 9. During this thermal expansion in progress, however, the columnar component 19 is pressed by the rim of the hole 15a to be moved in a lateral outward direction, and an upward movement of the hole 15a is not hampered by the columnar portion 19b, so that the thermal expansion of the light guide plate 15 is prevented from being inhibited. This suppresses the generation of thermal stress in the light guide plate 15, and thus there hardly occurs bending or the like of the light guide plate 15.

Furthermore, after the light guide plate 15 has undergone the thermal expansion, when, for example, the power of the backlight device 1 is turned off to cause the LEDs 13a to stop the light emission, the light guide plate 15 is cooled in a gradual manner. At this time, the light guide plate 15 contracts in a gradual manner to be released from the thermally expanded state and is eventually brought back to the state shown in FIG. 8. Also during this contraction in progress, the columnar component 19 is pressed by the rim of the hole 15a to be moved in a lateral inward direction, and a downward movement of the hole 15a is not hampered by the columnar portion 19b, so that the contraction of the light guide plate 15 is prevented from being inhibited. This smoothly brings the light guide plate 15 back to its original state before being thermally expanded.

The above-described flexibility area can be preset to have a desired size by adjusting in advance a movable range of the columnar component 19, the size of the hole 15a, or the like. In general, the larger the size of the flexibility area that is preset, the easier it becomes to prevent thermal expansion of the light guide plate 15 from being inhibited. This, however, is likely to result in the light guide plate 15 being fixed loosely (particularly in the vertical and lateral directions). It is therefore preferable that the flexibility area be preset to have a smallest possible size that still serves the purpose of preventing thermal expansion of the light guide plate 15 from being inhibited, which occurs due to heat accompanying light emission by the LEDs 13a being conducted thereto.

As one example, with respect to the shape of the light guide plate 15 under a normal ambient temperature (for example, 20° C.), a steady state (first steady state) of the light guide plate 15 when the LEDs 13a are in a non-light emitting state and a steady state (second steady state) of the light guide plate 15 when thermally expanded to a sufficient degree due to heat accompanying light emission by the LEDs 13a being conducted thereto are determined in advance.

It is preferable that the flexibility area be preset to have such a size as not to inhibit thermal expansion and contraction of the light guide plate 15 (as to prevent the generation of thermal stress) during the transition between the first steady state and the second steady state. In this embodiment, the size of the flexibility area is preset appropriately in the above-described manner.

[Other Modifications and Variations]

As described in the foregoing, the backlight device 1 according to this embodiment includes the LEDs 13a (light sources) and the light guide plate 15 that receives light emitted by the LEDs 13a and emits it from the light emitting surface thereof. Furthermore, the backlight device 1 further includes the fixing mechanism for fixing the light guide plate 15 to the main body side of the backlight device 1 (in this embodiment, particularly, the metal frame 11) by using a structure that does not inhibit thermal expansion of the light guide plate 15 (in other words, a structure having a flexibility area).

Furthermore, the structure that does not inhibit thermal expansion of the light guide plate 15 is set so as not to inhibit thermal expansion of the light guide plate 15 during the transition from the state (first state) of the light guide plate 15 when the LEDs 13a are in a non-light emitting state to the state (second state) of the light guide plate 15 when thermally expanded due to heat accompanying light emission by the LEDs 13a being conducted thereto.

Thus, according to the backlight device 1, even when the light guide plate 15 undergoes thermal expansion due to heat accompanying light emission by the LEDs 13a being conducted thereto, the thermal expansion is prevented from being inhibited, and thus the generation of thermal stress is suppressed, so that bending or the like of the light guide plate 15 can be suppressed.

Typically, thermal expansion of the light guide plate 15 occurs to a considerable degree particularly in the direction parallel to the light emitting surface of the light guide plate 15. In this embodiment, the structure that does not inhibit thermal expansion of the light guide plate 15 is provided with respect to the direction parallel to the light emitting surface of the light guide plate 15 (in other words, a direction in which a plane parallel to the light emitting surface of the light guide plate 15 extends). Thus, bending or the like of the light guide plate 15 can be suppressed effectively.

Furthermore, the fixing mechanism according to this embodiment has the columnar component 19 (particularly, the columnar portion 19b) that is provided in a main body of the backlight device 1 so as to protrude perpendicularly to the direction parallel to the light emitting surface of the light guide plate 15 and the hole 15 that is provided through the light guide plate 15, and the light guide plate 15 is fixed in a state where the columnar component 19 is fitted into the hole 15a. The structure that does not inhibit thermal expansion of the light guide plate 15 is realized based on a combination of the facts that the columnar component 19 is movable and that a gap is provided between an outer rim of the columnar portion 19b and an inner rim of the hole 15a.

As for a specific configuration of the fixing mechanism, any of various configurations can be adopted as long as it serves the purpose of preventing, even when the light guide plate 15 undergoes thermal expansion due to heat accompanying light emission by the LEDs 13a being conducted thereto, such thermal expansion from being inhibited.

As one example, as shown in FIG. 10 (a modification obtained by modifying part of the configuration shown in FIG. 8), a configuration is possible in which the columnar component 19 is replaced with a column 19b1 that is immovably fixed to the side of the metal frame 11, and the hole 15a is replaced with a hole 15a1 having an increased width in the lateral direction.

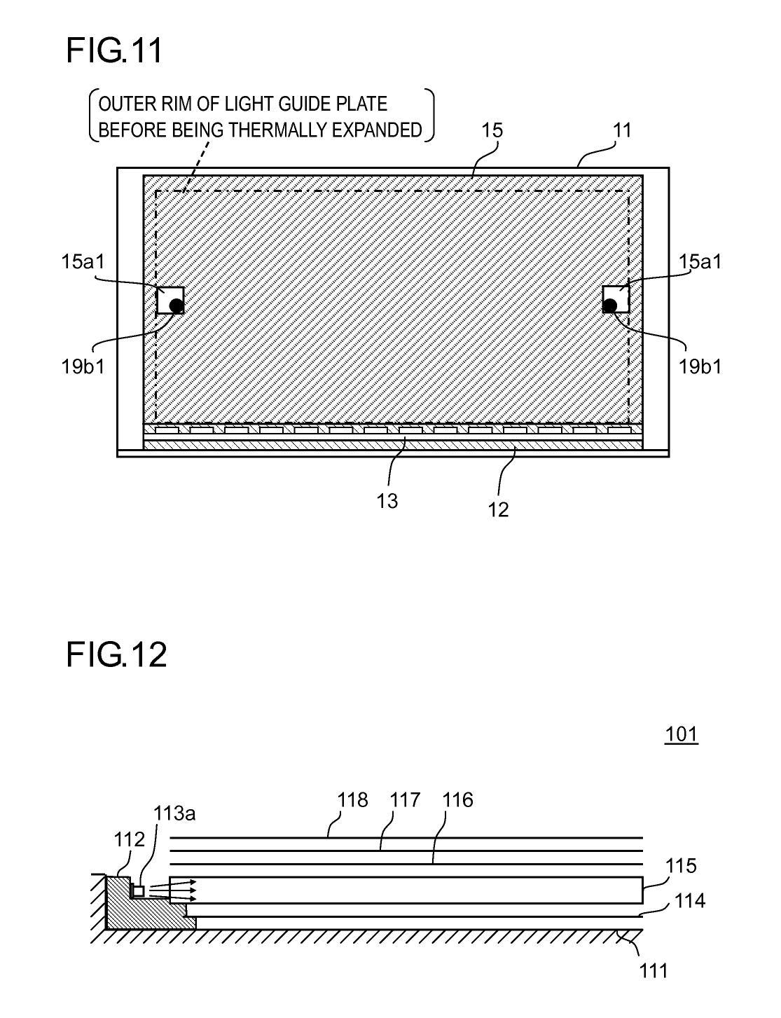

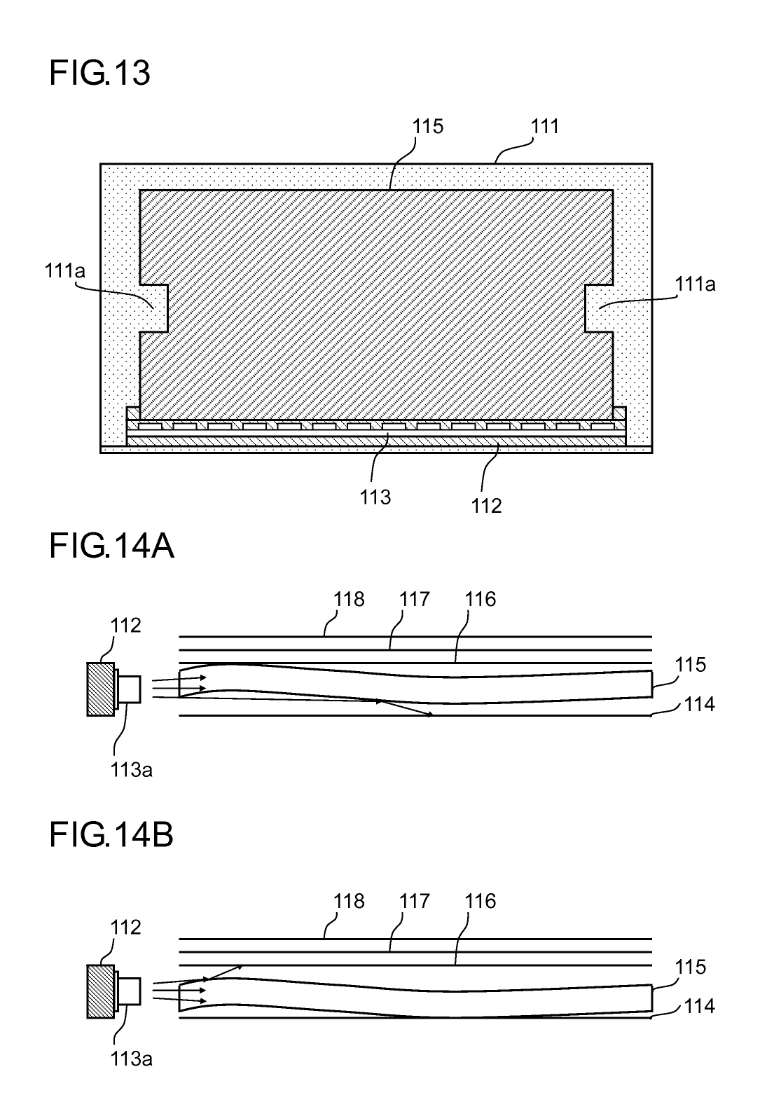

In this case, when the LEDs 13a are in a non-light emitting state, the light guide plate 15 is brought to a state shown in FIG. 10, and when thermally expanded due to heat accompanying light emission by the LEDs 13a being conducted thereto, the light guide plate 15 is brought to a state shown in FIG. 11. As the light guide plate 15 is thermally expanded, the hole 15a1 is positionally shifted, whereas the column 19b1 is prevented from being forcibly pressed against an inner rim of the hole 15a1, and thus the generation of thermal stress in the light guide plate 15 is suppressed.

Furthermore, the backlight device 1 combined with a liquid crystal panel and so on can constitute a liquid crystal display apparatus. That is, the liquid crystal display apparatus includes the backlight device 1 that emits, from the light emitting surface, light to be used as backlight, and the liquid crystal panel that has a plurality of pixels and in which the degree of transmission of the backlight is adjusted for each of the plurality of pixels so that an image is displayed. The liquid crystal display apparatus thus can enjoy the advantages of the backlight device 1.

Furthermore, although this embodiment adopts an LED as a light source, other types of light sources may be adopted. Examples of types of light sources that can be adopted include an organic EL lamp and a CCFL (cold cathode fluorescent lamp). Furthermore, although in this embodiment, the light emitting device according to the present invention is applied as a backlight device for a liquid crystal display apparatus, the light emitting device can also be applied variously in other forms.

The embodiment of the present invention having been discussed thus far is not intended to limit the present invention thereto. Furthermore, the embodiment of the present invention may be variously modified without departing from the spirit of the present invention.

Furthermore, according to the light emitting device of the present invention, even when the light guide plate undergoes thermal expansion, the thermal expansion is prevented from being inhibited, and thus the generation of thermal stress is suppressed, so that bending or the like of the light guide plate can be suppressed. Furthermore, according to the liquid crystal display apparatus of the present invention, it is possible to enjoy the advantages of the light emitting device of the present invention.

What is claimed is:

1. A light emitting device, comprising:
a light source; and
a light guide plate that receives light emitted by the light source and emits it from a light emitting surface thereof,
wherein there is provided a fixing mechanism for fixing the light guide plate to a main body side of the light emitting device by using a structure that does not inhibit thermal expansion of the light guide plate.

2. The light emitting device according to claim 1, wherein
the structure that does not inhibit thermal expansion of the light guide plate is set so as not to inhibit thermal expansion of the light guide plate during a transition from a first state to a second state,
the first state is a state of the light guide plate when the light source is in a non-light emitting state, and
the second state is a state of the light guide plate when thermally expanded due to heat accompanying light emission by the light source being conducted thereto.

3. The light emitting device according to claim 2, wherein
the structure that does not inhibit thermal expansion of the light guide plate is provided with respect to a direction parallel to the light emitting surface of the light guide plate.

4. The light emitting device according to claim 3, wherein
the fixing mechanism comprises:
a column that is provided on the main body side so as to protrude perpendicularly to the direction parallel to the light emitting surface of the light guide plate; and
a hole that is provided through the light guide plate, the fixing is performed in a state where the support is fitted into the hole, and the structure that does not inhibit thermal expansion of the light guide plate is realized based on at least one of facts that the support is movable and that a gap is provided between an outer rim of the support and an inner rim of the hole.

5. The light emitting device according to claim 1, wherein
the light source is an LED that is disposed so as to be opposed to a side surface of the light guide plate.

6. A liquid crystal display apparatus, comprising:
the light emitting device according to claim 1 that emits, from the light emitting surface, light to be used as backlight; and
a liquid crystal panel that has a plurality of pixels and in which a degree of transmission of the backlight is adjusted for each of the plurality of pixels so that an image is displayed.
